(19) United States
(12) Patent Application Publication
(10) Pub. No.: US 2016/0236413 A1
(43) Pub. Date: Aug. 18, 2016

(54) NOZZLE COVER COATING

(71) Applicants: Michael Daniel Armani, Bethesda, MD (US); David Souza Jones, Burtonsville, MD (US)

(72) Inventors: Michael Daniel Armani, Bethesda, MD (US); David Souza Jones, Burtonsville, MD (US)

(21) Appl. No.: 14/841,674

(22) Filed: Aug. 31, 2015

Related U.S. Application Data
(60) Provisional application No. 62/117,439, filed on Feb. 17, 2015.

(51) Int. Cl. B29C 67/00; B29C 47/12

(52) U.S. Cl. CPC B29C 67/0085; B29C 67/0055; B29C 47/12; B29K 2883/00; B29K 2885/00; B33Y 30/00

(57) ABSTRACT

A nozzle and cover for use in 3D printing, including a nozzle body having a relatively flattened end; a nozzle tip protruding a small distance from the flattened end; a disk of material surrounding the nozzle tip, the disk being in contact with the flattened end; and wherein the disk of material prevents sticking of plastic and thereby prevents charring. The device further includes providing the disk of material being composed of PTFE or silicone.

### CROSS REFERENCE TO RELATED APPLICATIONS

This application claims the priority of Provisional Application No. 62/117,439 filed on Feb. 17, 2015, inventors Michael Daniel Armani and David Souza Jones, entitled “3D Printer”. The entire disclosure of this provisional patent application is hereby incorporated by reference thereto, in its entirety.

### STATEMENT REGARDING FEDERALLY SPONSORED RESEARCH OR DEVELOPMENT Not applicable.

### FIELD OF THE INVENTION

The present invention relates to a nozzle, nozzle cover, tip, and protective member, especially for use in 3D printers.

### BACKGROUND OF THE INVENTION

It is a problem in the art to provide a printer extruder nozzle for use in 3D printing that reduces charring and burning; is child-safe; and reduces and/or prevents odors.

### SUMMARY OF THE INVENTION

From the foregoing, it is seen that it is a problem in the art to provide a device and meeting the above requirements. According to the present invention, a device is provided which meets the aforementioned requirements and needs in the prior art. Specifically, the device according to the present invention provides a nozzle cover or coating that prevents sticking and charring of plastic on 3D printers.

Specifically, a cover or coating on the end of a 3D printer nozzle, such as silicone or PITT, prevents plastic from getting stuck on the nozzle and also prevents plastic near the nozzle end from overheating or charring or excessive fumes from charring plastic. Imagine you are cooking food on the stove. It smells good as long as the food is in the pan. Once the food falls out of the pan onto the hot heating elements, it starts to char and create very foul smelling fumes. This is the same as in 3D printing. By covering the tip of the nozzle with a protective coating, you reduce the amount of heat that can be dumped into plastic near the end of the nozzle. By using silicone or PTFE on the tip, the plastic also doesn't stick as well as it would to hot metal. This prevents the plastic from staying on the nozzle long enough to char and create foul odors and prevents charring of the plastic.

Other objects and advantages of the present invention will be more readily apparent from the following detailed description when read in conjunction with the accompanying drawings.

### BRIEF DESCRIPTION OF THE DRAWINGS

FIG. 1 is a schematic perspective view of a nozzle assembly for use in printing 3D articles in a 3D printer.

FIG. 2 is a front view of the nozzle assembly of FIG. 1.

FIG. 3 is a view similar to FIG. 2, and showing internal details of the nozzle assembly.

FIG. 4 is a view similar to FIG. 3, and showing internal details of an alternative embodiment of the nozzle assembly.

FIG. 5 is a side view of a 3D printer with an extruder carrying the nozzle assembly of FIGS. 1-3.

### DETAILED DESCRIPTION OF THE INVENTION

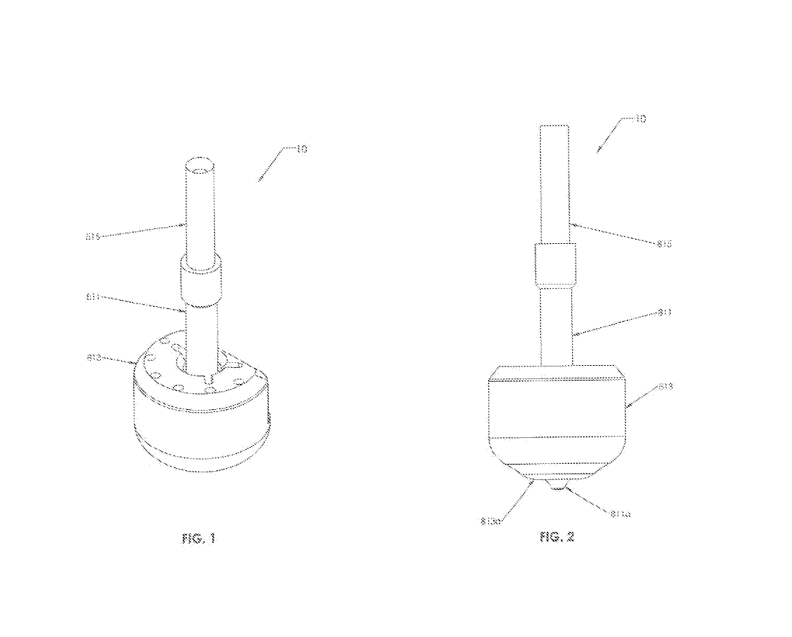

FIG. 1 is a schematic perspective view of a nozzle assembly 10 for use in printing 3D articles in a 3D printer 1 (shown in FIG. 5). An internal nozzle tube 815 is inside of nozzle 811. The nozzle assembly 10 indicates a nozzle 811 and a nozzle cover 813.

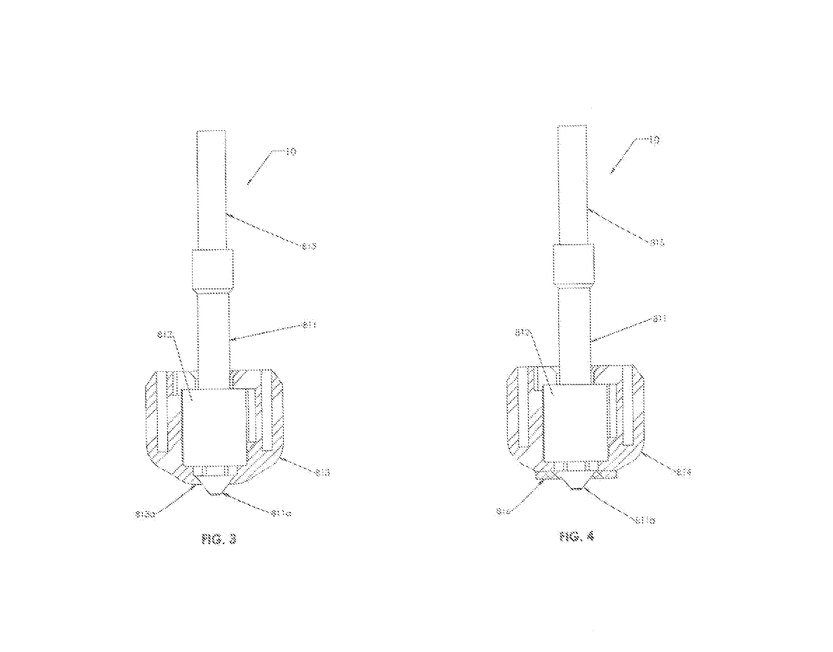

FIG. 2 is a front view of the nozzle assembly 10 and nozzle cover 813 of FIG. 1. The nozzle cover 813 includes a thin disk-shaped member 813a surrounding the nozzle tip 811a.

FIG. 3 is a view similar to FIG. 2, and showing internal details of the nozzle cover 813. In this view, a heating element 812 is depicted. The two wires leading to heating element 812 are not shown.

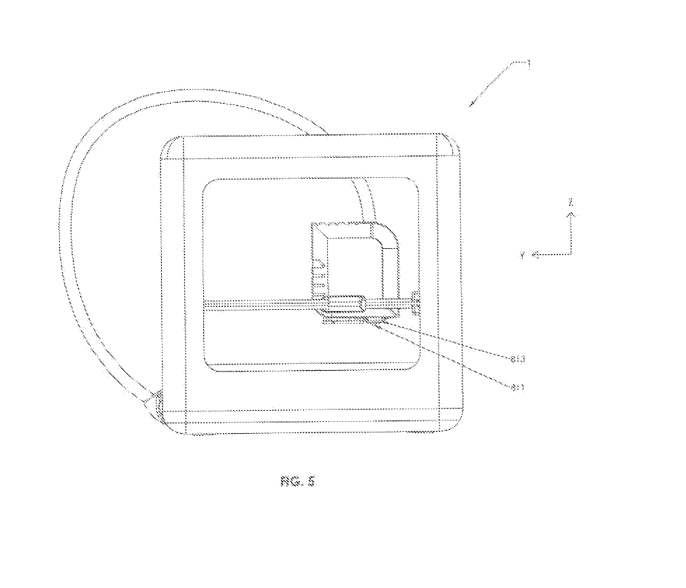

FIG. 4 is a view similar to FIG. 3, and showing an alternative embodiment of nozzle cover 813 in a two-part design comprised of nozzle cover alternative 814 and nozzle cover disk 816. Nozzle cover disk 816 is in close contact with the bottom of nozzle cover alternative 814, and is described further hereunder.

FIG. 5 is a side view an extruder on 3D printer 1 carrying the nozzle 811 and nozzle cover 813 of FIGS. 1-3.

Specifically, the nozzle cover 813 has the disk-shaped member 813a surrounding the nozzle 811a of the 3D printer nozzle 811. Alternatively, disk-shaped member 813a may be formed as a coating on nozzle tip 811a on the internal and/or external surfaces of nozzle 811. A coating on nozzle 811 may be used in conjunction with disk-shaped member 813a or nozzle cover disk 816. Said coating could be a number of different high-temperature materials, including PTFE.

The member or coating 813a is formed of material such as silicone or PTFE, and prevents plastic from getting stuck on the nozzle and also prevents plastic near the nozzle end from overheating or charring or excessive fumes from charring plastic.

In an alternative embodiment, shown in FIG. 4, nozzle disk 816 is a separate component that is not part of nozzle cover 813 or nozzle cover alternative 814. It may be in the shape of an o-ring, X-profile o-ring, square o-ring, or any other type of disk-shaped seal.

As an example of this, imagine you are cooking food on the stove. When burning food, it smells good as long as the food is in the pan. Once the food falls out of the pan onto the hot heating elements, it starts to char and create very foul smelling fumes. This is the same as in 3D printing. By covering the tip of the nozzle with a protective coating, the amount of heat can be reduced that can be transmitted or dumped into plastic material (such as that of a printed article or from the extruded plastic material from the nozzle) which is disposed near the end of the nozzle 811. By using nozzle cover 813 on the nozzle tip 811a, the plastic also doesn't stick as well as it would to hot metal. This prevents the plastic from staying on the nozzle long enough to char and create foul odors and prevents charring of the plastic.

Additionally, this forms a child-safe feature. As seen in FIG. 3 and FIG. 5, the nozzle cover 813 is relatively very flat near the nozzle tip 811a, and when the 3D printer is in operation, nozzle cover 813 prevents a child from inserting an object or fingers closely to the nozzle tip 811a.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A nozzle and cover for use in 3D printing, comprising:
a nozzle body having a relatively flattened end;
a nozzle tip protruding a small distance from the flattened end;
a disk of material surrounding the nozzle tip, the disk being in contact with the flattened end;
wherein the disk of material prevents sticking of plastic and thereby prevents chaffing.

2. The device of claim 1, wherein the disk of material is composed of PTFE or silicone.
